(19) United States
(12) Patent Application Publication
(10) Pub. No.: US 2025/0194857 A1
(43) Pub. Date: Jun. 19, 2025

(54) LOCKING BLADE BASE AND BLEND CUP

(71) Applicant: VITA-MIX MANAGEMENT CORPORATION, Olmsted Township, OH (US)

(72) Inventors: Steve Rukavina, Olmsted Township, OH (US); Brandon Krise, Olmsted Township, OH (US); Brad Paskert, Olmsted Township, OH (US); Derek Slone, Olmsted Township, OH (US); Chris Stewart, Olmsted Township, OH (US)

(73) Assignee: VITA-MIX MANAGEMENT CORPORATION, Olmsted Township, OH (US)

(21) Appl. No.: 18/846,935

(22) PCT Filed: Mar. 15, 2023
(86) PCT No.: PCT/US2023/015258

§ 371 Date: Sep. 13, 2024

Related U.S. Application Data
(60) Provisional application No. 63/319,860, filed on Mar. 15, 2022.

(51) Int. Cl. A47J 43/07; A47J 43/046; B01F 35/222; B01F 35/60; B01F 101/00

(52) U.S. Cl. CPC A47J 43/0766; A47J 43/046; B01F 35/222; B01F 35/6052; B01F 2101/1805

(57) ABSTRACT

Provided is a blending system having a locking and/or sealing mechanism. The blending system may include a blending cup and a blade base having a blade assembly. The blending cup may have an open end and a closed end. The blade base may be selectively attachable to the open end of the blending cup and include the locking and/or sealing mechanism. The blade base may include a button corresponding to a protrusion that can selectively engage a mating groove on the blending cup to alternate between locked and unlocked positions. The blending system may be portable.

### CROSS REFERENCE TO RELATED APPLICATIONS

This application claims benefit of and priority to U.S. Patent Application No. 63/319,860, filed on Mar. 15, 2022, entitled “Locking Blade Base and Blend Cup,” which is incorporated herein by reference in its entirety.

### TECHNICAL FIELD

The present teachings relate to a blending system, and more particularly to a blending container for use with a blade base comprising a locking mechanism.

### BACKGROUND

Blenders and blending systems are often used to blend and process foodstuffs. Conventional blenders generally include a base coupled with a motor and a mixing container with an operable mixing blade disposed therein. A blender lid is adapted to cover the container. A user inserts contents within the mixing container to be mixed by the rotation of the blade. The container is positioned on the base as a user controls the operation of the motor within the base to rotate the mixing blade within the container to mix the contents therein. The contents are then transferred from the container to a personal cup or bottle. Such large format blending systems may not be suitable for all applications. Smaller and more portable blender cups, and blender cups for personal blenders, may be used for certain applications.

Frozen, frosty, or icy drinks have become increasingly popular. Such drinks include the traditional shakes, and the more recently popular smoothies. Shakes, or milkshakes, are typically formed of ice cream and/or milk, and flavored as desired, with or without additives, such as candies, chocolates, peanut butter, fruits, etc. Milkshakes typically are available at most fast-food restaurants, such as burger chains, and may be made by special machines, or hand-made using mixers. Smoothies tend to be healthier, and may be formed of ice, frozen yogurt, and/or sorbet. Smoothies may include additives such as fruits, fruit juice, vegetables, vitamins, supplements, etc. Smoothies typically are available from specialty chains or juice bars, and may be made with a commercial or restaurant-grade blender. Such drinks also may be made at home, using a personal blender. Soups, salsas, sauces, purees, nut or oat milks, and the like, may also be made using a blender or blending systems.

Many current blending systems generally require a container that is attachable to a motor housing at a closed end and that is used for blending of foodstuff, this container being separate from a cup that is used to deliver or consume the blended product. An open end of the container is used to receive foodstuff for blending and to transfer the blended product to a cup for delivery or consumption of the blended product.

Personal blending cups, having an open end that selectively attaches to a base coupled with a motor and an operable mixing blade, can leak when the base is not fully tightened to the cup. Such bases and cups can be difficult to attach and properly tightened to prevent or limit leaking of the blended product therein. Moreover, overtightened bases and cups may actually reduce the effectiveness of a seal, further causing leaks or reducing the life span of the seal and personal blending system. Overtightening of the components can also lead to difficulty in removing and detaching components for consumption and general ease of use.

Therefore, a need exists for improved blender systems and personal blender systems including an improved mating, locking, and/or sealing mechanisms. A need exists for improved blender systems that allow for improved ease of attachment between components to prevent under-tightening and/or over-tightening. A need exists for improved blender systems that facilitate improved assembly of the blending system, including inversion of a blending cup.

### SUMMARY

The following presents a summary of this disclosure to provide a basic understanding of some aspects. This summary is intended to neither identify key or critical elements nor define any limitations of embodiments or claims. Furthermore, this summary may provide a simplified overview of some aspects that may be described in greater detail in other portions of this disclosure.

Provided is a blending system having a locking and/or sealing mechanism. The blending system may include a blending cup and a blade base having a blade assembly. The blending cup may have an open end and a closed end. The blade base may be selectively attachable to the open end of the blending cup and include the locking and/or sealing mechanism. The blade base may include a button corresponding to a protrusion that can selectively engage a mating groove on the blending cup to alternate between locked and unlocked positions. The blending system may be portable.

### DESCRIPTION OF THE DRAWINGS

The present teachings may be better understood by reference to the following detailed description taken in connection with the following illustrations, wherein:

FIG. 1 is a perspective view of an embodiment of a blender system having a blending cup, a blade base, and a motor base in accordance with various disclosed aspects herein;

FIG. 2 is a perspective view of an embodiment of a blending cup of the blender system in accordance with various disclosed aspects herein;

FIG. 3 is a perspective view of an embodiment of a short blending cup of the blender system in accordance with various disclosed aspects herein;

FIG. 4 is an enlarged view of an embodiment of the engagement mechanism of the blending cup of FIGS. 2 and/or 3 in accordance with various disclosed aspects herein;

FIG. 5 is a perspective view of an embodiment of a blade base of the blender system in accordance with various disclosed aspects herein;

FIG. 6 is an enlarged view of an embodiment of the engagement mechanism of the blade base of FIG. 5 in accordance with various disclosed aspects herein;

FIG. 7 is a perspective view of an embodiment of a blending cup attached to a blade base in accordance with various disclosed aspects herein;

FIG. 8 is an enlarged view of an embodiment of a blending cup attached to a blade base in accordance with various disclosed aspects herein;

FIG. 9 is a cross-sectional view of FIG. 8 taken at line A-A and showing an embodiment of a blending cup attached to a blade base in accordance with various disclosed aspects herein;

FIGS. 10A-B are enlarged views of an embodiment of a blending cup attached to a blade base in accordance with various disclosed aspects herein;

FIG. 11 is a perspective view of an embodiment of a blade base of the blender system in accordance with various disclosed aspects herein;

FIG. 12 is a perspective view of an embodiment of a blending cup of the blender system in accordance with various disclosed aspects herein;

FIG. 13 is a perspective view of an embodiment of a short blending cup of the blender system in accordance with various disclosed aspects herein;

FIG. 14 is a cross-sectional view of FIG. 10B taken at line B-B and showing an embodiment of a blending cup attached to a blade base in accordance with various disclosed aspects herein;

FIGS. 15A-B are enlarged views of an embodiment of a blending cup attached to a blade base in accordance with various disclosed aspects herein;

FIG. 16 is a perspective view of an embodiment of a blade base of the blender system in accordance with various disclosed aspects herein;

FIGS. 17A-B are perspective views of an embodiment of a short blending cup of the blender system in accordance with various disclosed aspects herein;

FIG. 18 is a cross-sectional view of FIG. 15B taken at line C-C and showing an embodiment of a blending cup attached to a blade base in accordance with various disclosed aspects herein;

FIG. 19A is a top view of an embodiment of a blending cup attached to a blade base in accordance with various disclosed aspects herein;

FIG. 19B is an enlarged view of an embodiment of a blending cup attached to a blade base in accordance with various disclosed aspects herein;

The invention may be embodied in several forms without departing from its spirit or essential characteristics. The scope of the invention is defined in the appended claims, rather than in the specific description preceding them. All embodiments that fall within the meaning and range of equivalency of the claims are therefore intended to be embraced by the claims.

### DETAILED DESCRIPTION

Reference will now be made in detail to embodiments of the present teachings, examples of which are illustrated in the accompanying drawings. It is to be understood that other embodiments may be utilized, and structural and functional changes may be made without departing from the scope of the present teachings. Moreover, features of the embodiments may be combined, switched, or altered without departing from the scope of the present teachings, e.g., features of each disclosed embodiment may be combined, switched, or replaced with features of the other disclosed embodiments. As such, the following description is presented by way of illustration and does not limit the various alternatives and modifications that may be made to the illustrated embodiments and still be within the spirit and scope of the present teachings.

As used herein, the words “example” and “exemplary” mean an instance, or illustration. The words “example” or “exemplary” do not indicate a key or preferred aspect or embodiment. The word “or” is intended to be inclusive rather an exclusive, unless context suggests otherwise. As an example, the phrase “A employs B or C,” includes any inclusive permutation (e.g., A employs B; A employs C; or A employs both B and C). As another matter, the articles “a” and “an” are generally intended to mean “one or more” unless context suggest otherwise.

It is noted that references to a blender, blender system, and the like, are understood to include other mixing systems. It is further noted that while various embodiments refer to a personal or portable blending cup and system, various other systems and containers may be utilized in view of embodiments described herein. For example, embodiments may be utilized in food processor systems, hand-held mixing systems and electric whisks, and various other food preparation systems or other kitchen appliances. Other containers may also be utilized, including conventional containers having a blade assembly and a containers configured to receive a lid. For example, the locking and sealing mechanisms herein may be used to selectively attach containers to blade bases, containers to lids, and the like. It is noted that blending containers as described herein includes personal cups, industrial or restaurant capacity containers, bowls, and the like.

Furthermore, while blending of “ingredients,” “contents,” or “foodstuffs” is described by various embodiments, it is noted that non-food stuff may be mixed or blended, such as paints, epoxies, construction material (e.g., mortar, cement, etc.), and the like. Moreover, blending of ingredients may result in a blended product. Such blended products may include drinks, frozen drinks, smoothies, shakes, soups, purees, salsas, sauces, sorbets, butters or milks (e.g. nut or oat), dips or the like. Accordingly, such terms may be used interchangeably unless context suggests otherwise or warrants a particular distinction among such terms. Further, such terms are not intended to limit possible blended products and should be viewed as examples of possible blended products.

As used herein, the phrases “blending process,” “blending program,” and the like are used interchangeably unless context suggest otherwise or warrants a particular distinction among such terms. A blending process may comprise a series or sequence of blender settings and operations to be carried out by the blending device. In an aspect, a blending process may comprise at least one motor speed and at least one time interval for the given motor speed. For example, a blending process may comprise a series of blender motor speeds to operate the blender blade at the given speed, a series of time intervals corresponding to the given motor speeds, and other blender parameters and timing settings. The blending process may further include a ramp up speed that defines the amount of time the motor takes to reach its predetermined motor speed. The blending process may be stored on a memory and recalled by or communicated to the blending device.

In some traditional blending systems, foodstuff is placed into a blending container for blending. After blending, a user may remove the blended product from the blending container. In an aspect, the user typically either pours the content out of the blending container and into another container or consumes the product directly from the blending container. In either case, the blending container will have remnants therein after consumption. This typically requires the user to clean the blending container. In other instances, the user may throw out the blending container (e.g., such as when the blending container is disposable).

Blending containers in some traditional blending systems require selective attachment to a lid in order to keep foodstuff contained therein during blending and in other blending systems, such as personal blending systems, an open end of the blending container may be inverted and selectively attach onto a base coupled with a motor and an operable mixing blade. In either case, the blending systems can leak through the attachment of the blending container to the lid or to the base. For example, inverted blending containers and separate blade assembly systems may be particularly susceptible to leaking of foodstuff due to the proximity of the blade assembly to the open end of the blending container. Moreover, the foodstuff and blended contents (before, during, and after blending) may sit on and seep through this attachment of the blending container to the base. Such inverted systems or personal blending systems may be difficult to attach without under-tightening or over-tightening the blending container to the base. This variable and imprecise attachment may cause leaks, may stress and eventually break the sealing mechanisms, and may increase difficulty in use, such as in removing and detaching components for consumption.

Embodiments disclosed herein relate to cup or personal blender systems and methods. Disclosed cup or personal blender systems generally include a housing, a motor, a power source, and a blade assembly. The housing contains the motor and power source. The motor drives the blade assembly. A controller 455 may control operation of the motor. Such cup or personal blender systems are operatively utilized to mix or blend contents within a cup or other vessel in which a user may consume a blended product. As such, described cup or personal blenders are typically hand held devices such that sizes and arrangements of components are often critical compared to large format blending systems.

It is noted that large format blending systems may include household blenders, commercial blenders, food processors, or the like. Such systems typically include a blender base that receives a dedicated blender container, wherein the blender container includes or is coupled with a blade assembly. Such large format blending systems are not subject to similar constraints as cup blenders. Further, containers for such large format blending systems are generally specific to or designed for use with blender bases. These containers may come in different sizes (e.g., single serving, pitchers, etc.) but are typically designed to assist in the fluid dynamics of large format blending systems. Accordingly, teachings from such large format blending systems are generally not directly applicable to cup blenders.

Provided is a blending system having a locking and/or sealing mechanism. The blending system may include a blending cup and a blade base having a blade assembly. The blending cup may have an open end and a closed end. The blade base may be selectively attachable to the open end of the blending cup and include the locking and/or sealing mechanism. The blade base may include a button corresponding to a protrusion that can selectively engage a mating groove on the blending cup to alternate between locked and unlocked positions. The blending system may be portable.

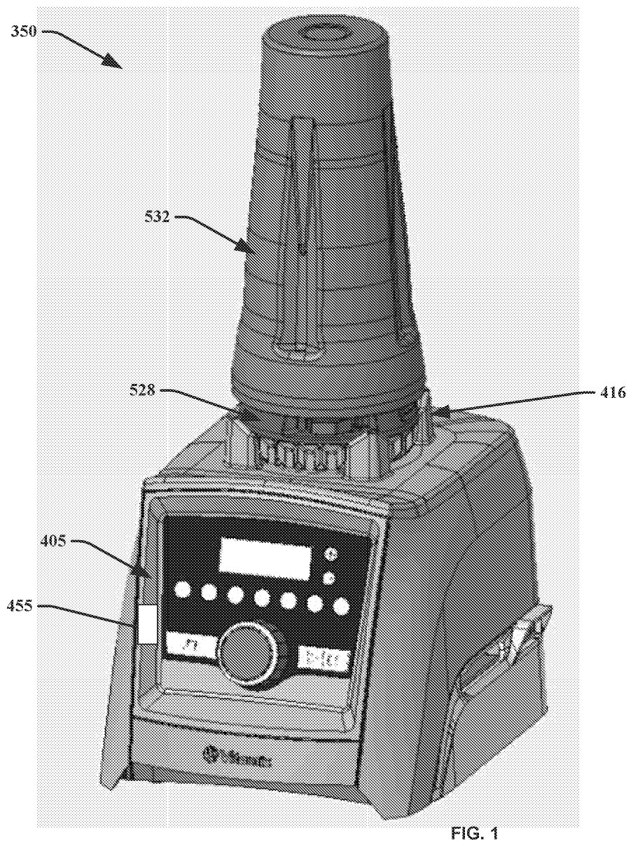

FIG. 1 shows blending system 350 comprising a motor base 405, blending container 532, and blade base 528 operatively attached to the blending container 532 and the motor base 405 at opposite ends. The motor base 405 may house a motor that operatively powers and drives the blades of the blade base 528 as further described herein. In some embodiments, the controller 455 may control operation or at least certain operation or non-operation of the motor. An example of this control is shown in U.S. Publication No. 2020/0275807A1, which is incorporated herein by reference in its entirety.

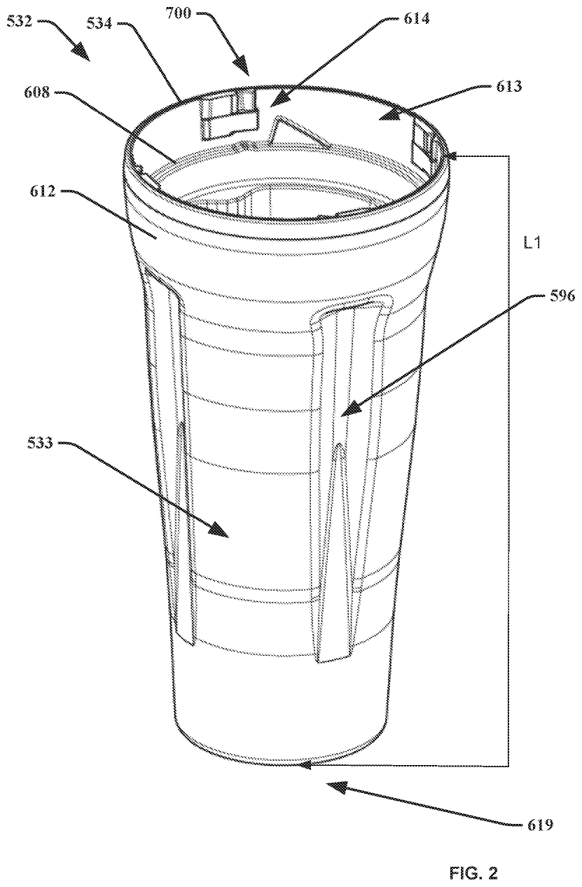

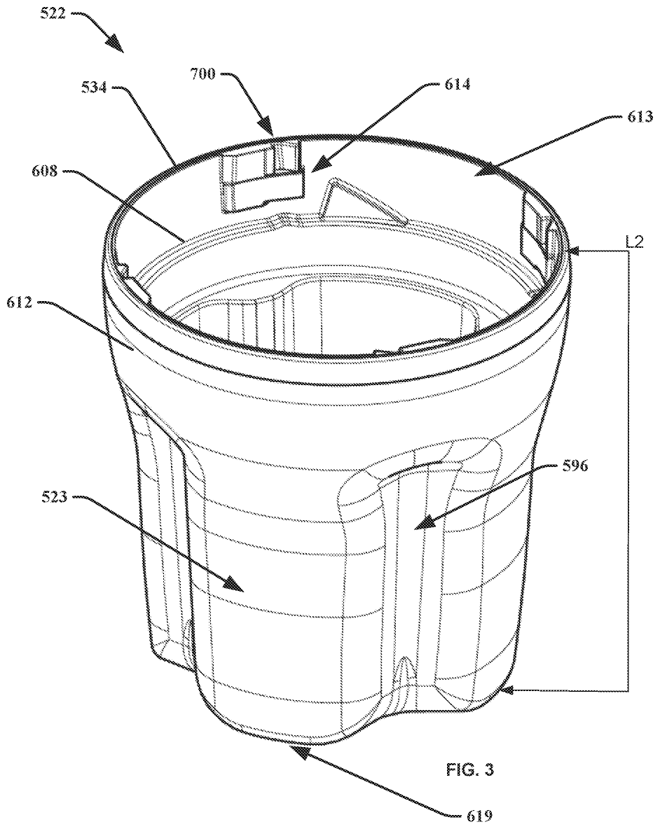

Turning to FIGS. 2-3, shown are blending containers 532, 522. In an embodiment shown in FIG. 2, the blending container 532 includes at least one sidewall 533 extending to a lip or rim 534. The rim 534 can be a squared rim, rounded rim, have a ledge, etc. The blending container 532 may be a double-walled container (e.g. having an inner layer spaced apart from an outer layer), single-walled container, or the like. The at least one sidewall 533 may be generally circular. In an embodiment shown in FIG. 3, the blending container 522 includes at least one sidewall 523 extending to a lip or rim 534. The rim 534 can be a squared rim, rounded rim, have a ledge, etc. The blending container 522 may be a double-walled container (e.g. having an inner layer spaced apart from an outer layer), single-walled container, or the like. The at least one sidewall 523 may be generally circular.

As shown in FIG. 2, for blending container 532, the length of the at least one sidewall 533 may be a first length L1. As shown in FIG. 3, for blending container 522, the length of the at least one sidewall 523 may be a different, e.g., it may be of a shorter length L2. Blending containers 532, 522 of any capacity may be used in the present disclosure, including blending containers having the general shapes shown in FIGS. 2-3. Blending containers 532, 522, in an example, may have all or some of the same features as described herein except for the capacity or length of corresponding sidewalls 533, 523. Any aspects described in reference to blending container 532 may also be applied to blending container 522 and vice versa, but may not be explicitly repeated for sake of brevity. It is noted that blending containers 532, 522 may be interchangeable with the same blade base 528 or other blade bases as described herein.

In an embodiment, the blending container 532 may be generally cylindrical, conical, or frustoconical, the closed end or open end generally circular (e.g. having a general circumference), and the sidewall(s) generally curved or round. It is also noted, however, that the blending container 532 may comprise any size and shape as desired, including round, square, rectangular, irregular, or the like. Additionally, the blending container 532 may comprise multiple shapes, for example the closed end or open end generally circular while the sidewall(s) are squared. It is noted that terms such as circumference, diameter, etc., while including round, circular, and cylindrical shapes, may also refer to the periphery or general aspects of a non-circular or round shape, such as a squared shape.

Further, unless context suggests otherwise, descriptions of shapes (e.g., circular, rectangular, squared, triangular, etc.) and the nature of the shapes (e.g., straight, curved, rounded, etc.) refer to shapes meeting the definition of such shapes and general representation of such shapes. For instance, a triangular shape or generally triangular shape may include a shape that has three sides and three vertices or a shape that generally represents a triangle, such as a shape having three major sides that may or may not have straight edges, triangular like shapes with rounded vertices, etc. Additionally, as used herein, the word near may be used to describe an aspect that is directly adjacent to or at another aspect, relatively close to another aspect, that is within 1-3 cm.

Moreover, a sidewall may have any number of sides, such as 1, 2, 3, 4, 5, 6, 7, 8, 9, 10, etc. sides, and may generally adopt the shape of a parallelogram, circle, rectangle, square, portion of any of the foregoing, or the like. A sidewall or sidewalls, although encompassing a cavity therein, may also be referred to in a singular form or a plural form. Edges and corners of sidewall(s), or portions connecting sidewall(s), may similarly have any number of sides, such as 1, 2, 3, 4, 5, 6, 7, 8, 9, 10, etc. sides, and may generally adopt the shape of a parallelogram, circle, rectangle, square, portion of any of the foregoing, or the like. Although general measurements or indications of height, length, width, distance, thickness, and angles may be disclosed, it is noted that these aspects are broadly defined within this disclosure unless specifically indicated for a particular embodiment.

The blending container 532 may include elongated ribs or flutes 596 projecting from an interior side 608 of the blending container 532 and into a cavity or blending area. The elongated ribs or flutes 596 may also correspond to a depression on the exterior side 612 of the blending container 532. The ribs 596 may comprise one or more protrusions generally spanning a length or a substantial length of the at least one side wall 533 or of the blending container 532. In an example, the ribs 596 may span from a point at, near or adjacent to an open end 613 to a point at, near or adjacent to a closed end 619 of the blending container 532. In an example, the ribs 596 may span from a point spaced apart from or below the open end 613 to a point spaced apart from or below the closed end 619 of the blending container 532. It is also noted that the ribs 596 may include any combination of the above, including ribs 596 may be spaced apart from the open end 613 but may extend up to the closed end 619, etc.

The ribs 596 may have generally the same width across its lengths, or the ribs 596 may taper towards either or both ends. As shown in FIG. 2, in an example, the blending container 532 may comprise at least two ribs 596 spaced at opposing sides of the blending container 532. As shown in FIG. 2, in an example, the blending container 532 may comprise four ribs 596 spaced evenly around the at least one sidewall 533 and at opposing sides of the blending container 532. It is noted that the blending container 532 may comprise any number of ribs 596 as desired including 1, 2, 3, 4, 5, 6, 7, 8, 9, 10, etc., and may have the same or differing shapes or positions on the at least one side wall 533 or on the blending container 532. The ribs 596 may be configured to aid in agitating the contents of the blending container 532 during blending. The blending container 532 may also include a plurality of fins.

As described, the blending container 532 may include the open end 613 through which material or foodstuff may be inserted in advance of blending and through which material or foodstuff may exit after blending. The open end 613 may be of any appropriate configuration and size. The open end 613 may be of a configuration to permit a user to drink directly therefrom. This may result in the blending container 532 being capable of utilization as a drinking vessel.

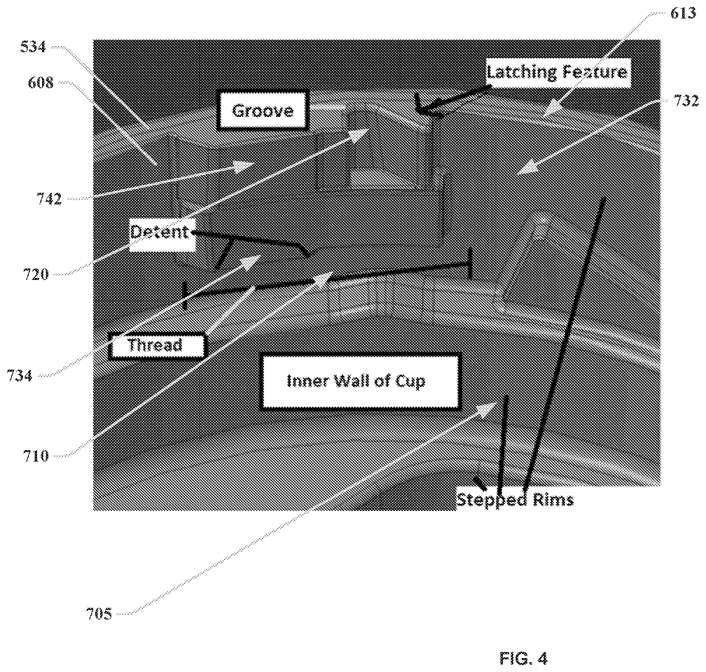

As shown in FIG. 4, the blending container 532 may include an engagement mechanism 614 configured to operatively and selectively engage with a corresponding engagement mechanism 672 of the blade base 528. The engagement mechanism 614 may be of any appropriate configuration and type, including, in an example, threading, bayonet connectors, fasteners, other mating protrusions and recesses, or the like. In an embodiment, the engagement mechanism 614 may be located at or near the open end 613 of the blending container 532 and on the interior side 608 of the blending container 532. The engagement mechanism 614 may include stepped rims 705. The stepped rims 705 may include different locking mechanisms and, in an embodiment, may allow different adaptors or bases to attach. An expanded view of an embodiment of the engagement mechanism 614 is shown in FIG. 4. It is noted that the engagement mechanism 614 may also be referred to as and include a locking or sealing mechanism and that locking mechanism 700 may generally refer to the engagement mechanism 614 of the blending container 532 and the corresponding engagement mechanism 672 of the blade base 528. The engagement mechanism 614 of the blending container 532 may selectively engage with or interlock with a corresponding portion of the blade base 528, e.g., engagement mechanism 672 of the blade base 528 as described herein.

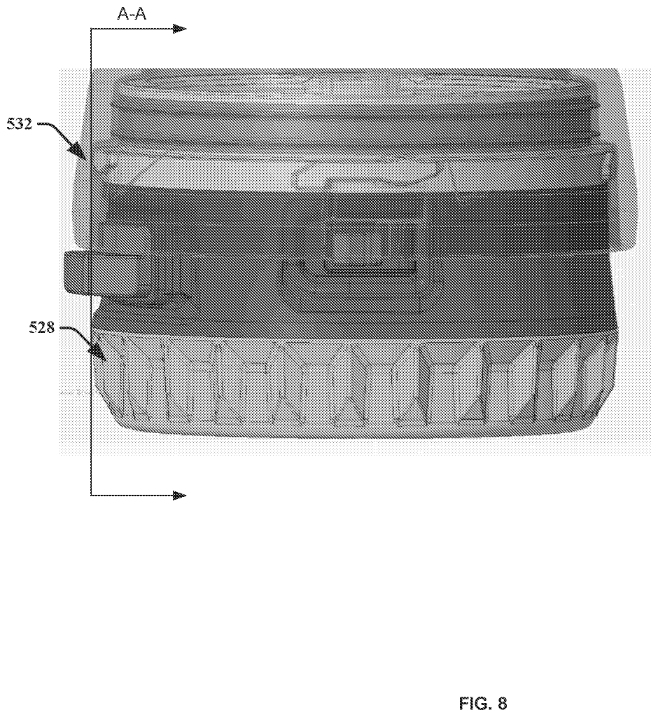

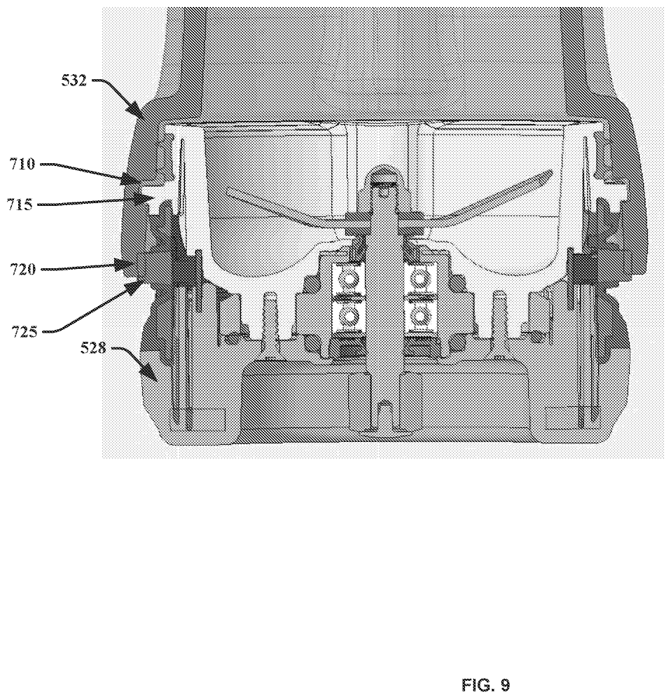

In an embodiment, the locking mechanism 700 of the blending container 532 may include threads 710 configured to receive corresponding threads or lugs 715 of the blade base 528, see FIGS. 8-9 showing engagement of the blending container 532 and the blade base 528. The threads 710 may be disposed within or on an inner wall 608 of the blending container 532 and at or near the open end 613 of the blending container 532. The engagement mechanism 614 may further include a lead in feature 732 of any appropriate configuration. The lead in feature 732 may direct the corresponding threads or lugs 715 of the blade base 528 into the engagement mechanism 614. The lead in feature 732 may make attachment of the locking mechanism 700 and securing to the blade base 528 easier for the user. The engagement mechanism 614 may include a physical stop or detent 734 to stop the blade base 528 from continuing to rotate relative to the blending container 532 once a certain desired threading has been engaged.

In an embodiment, the blending container engagement mechanism 614 of the locking mechanism 700 may include a locking groove 720 disposed within or on an inner wall 608 of the blending container 532 and at or near the open end 613 of the blending container 532. In an embodiment, the locking groove 720 may be configured to receive a corresponding locking member or protrusion 725 from an actuator or button 727 of the blade base 528 see FIGS. 8-9 showing engagement of the blending container 532 and the blade base 528. The engagement mechanism 614 may be formed within the blending container 532 such that the surface is flush except for the groove 720. In an example, the engagement mechanism 614 may include a reinforced area 742 which protrudes from the inner wall 608 of the blending container 532.

In an embodiment, the locking groove 720 of the blending container engagement mechanism 614 is configured to selectively engage the corresponding locking protrusion 725 of the blade base engagement mechanism 672, to thereby engage and selectively couple, lock, and/or seal the blending container 532 with the blade base 528. In an embodiment, the blending container 532 includes a sealed position to form a liquid tight seal with the outer side of the blade base 528. In an embodiment, the seal may be a pressure release seal of any appropriate configuration where liquid or air can be released when a certain pressure is reached. This may reduce pressure build up within the blending container 532.

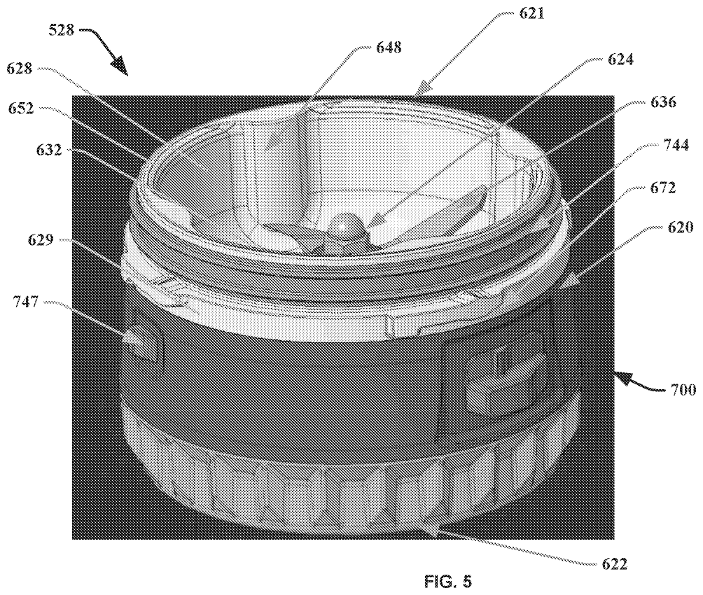

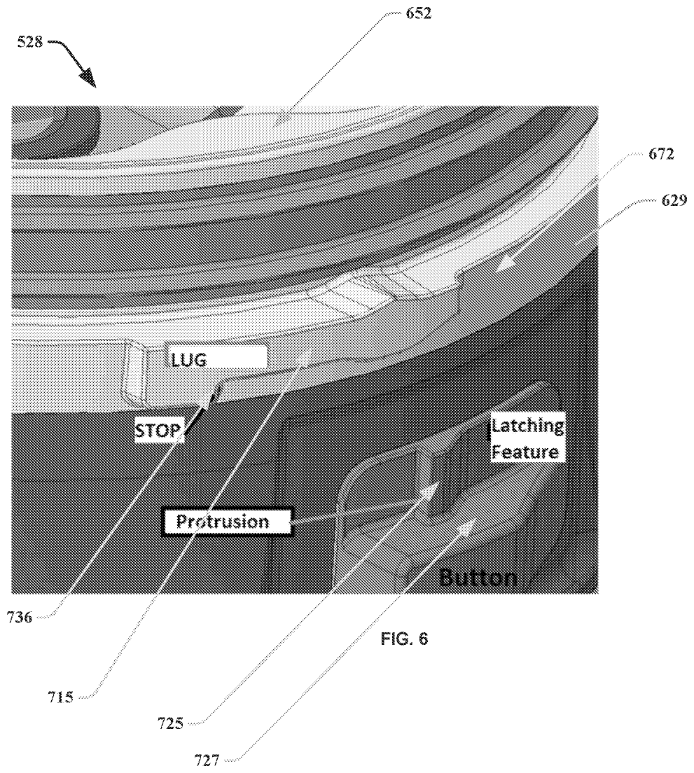

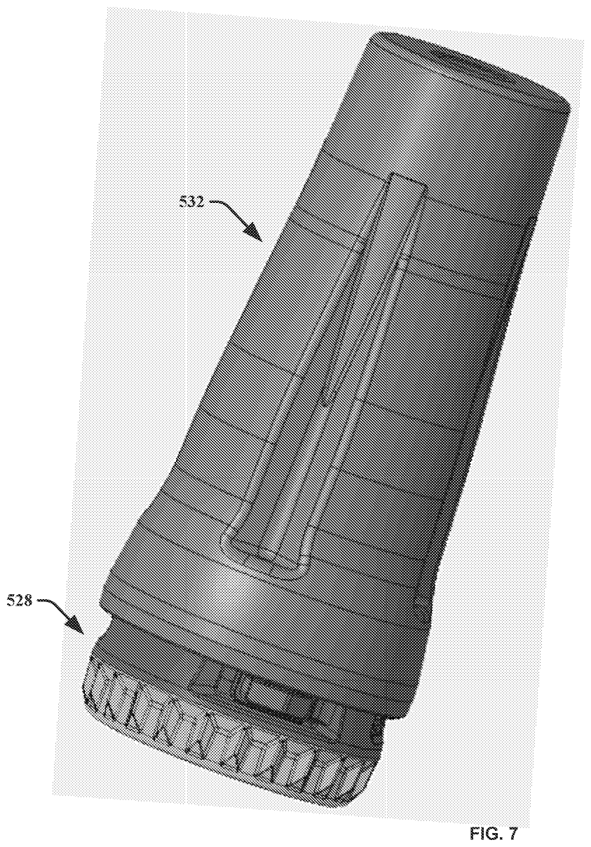

Turning to FIGS. 5-6, shown is an embodiment of a blade base 528. The blade base 528 may be sized and shaped to operatively fit within an opening or mount 416 in the motor base 405 in any appropriate manner. The blade base 528 may include a housing 620 having a first side 621 and a second side 622. A blade assembly 624 is positioned within the first side 621 of the housing 620. The housing 620 may be of any appropriate configuration. For example, the housing 620 may include an inner wall 628 that is rectangular and wherein the corners are used for agitating the contents of the attached blender container 532. For example, the housing 620 may include an inner wall 628 and an outer wall 629 that is generally circular. In an embodiment, the housing 620 may be an over-molded water shield housing. In an embodiment, the housing 620 may make the blade base 628 dishwasher safe. The housing 620 may further include an ergonomic hand grip to facilitate blade base 628 assembly and removal from associated components within the system 350 and may engage with the motor base 405 centering pad. The blending container 532, 522 may be similarly ergonomic to facilitate blending container 532, 522 assembly and removal from associated components within the system 350.

In an embodiment, the blade base 528 may include features to agitate the flow of material with the blender container 532. For example, the blade base 528 may break up flow of material within the blender container 532 during operation of the blending system 350. In an embodiment, the blade base 528 may include one or more protrusions 648 extending from the inner wall 628 on the first side 621 of the blade base 528. The one or more protrusions 648 may be of any appropriate shape and size, such as generally rounded. The one or more protrusions 648 may be monolithically formed with the inner wall 628 or may be attached through a subsequent operation. The one or more protrusions 648 may be approximately ½ inch in diameter. The one or more protrusions 648 may extend from a length of the blade base 528 from a bottom surface 632 to an open top end 652. The area of the blade base 528 from its bottom surface 632 to its open top end 652 may provide additional area to facilitate blending of foodstuff and may provide a blend zone enclosure.

It will be appreciated that the blade base 528 may include more than one protrusions 648. As shown in FIG. 5, in an example, the blade base 528 may comprise at least two protrusions 648 spaced at opposing sides of the blade base 528. As shown in FIG. 5, in an example, the blade base 528 may comprise four protrusions 648 spaced evenly around the inner wall 628 and at opposing sides of the blade base 528. It is noted that the blade base 528 may comprise may comprise any number of protrusions 648 as desired including 1, 2, 3, 4, 5, 6, 7, 8, 9, 10, etc., and may have the same or differing shapes or positions on the inner wall 628 or on the blade base 528. The one or more protrusions 648, in an example, may assist in the blending process and may be used for agitation, etc. For example, the one or more protrusions 648 may direct foodstuff back towards the blade assembly 624 during blending and prevent the accumulation of foodstuff towards the sides of the blending container 532 where it may not be adequately blended.

The blade assembly 624 may be connected to the housing 620 in any appropriate manner. The blade assembly 624 may be of any appropriate configuration, type and size. The present teachings are not limited to the configuration shown and described. By way of a non-limiting example, the blade assembly 624 can be of a conventional blender blade configuration and, as such, includes a plurality of radially extending blades 636 that are carried by, and positioned above the bottom surface 632 of the blade base 528 by a vertically oriented blade shaft (not shown). The blade shaft may extend downwardly through the bottom surface of the blade base 528 to a second side of the blade base 528. A spline (not shown) may secure to the end of the blade shaft on the second side of the blade base 528. The spline of the blade shaft engages with a splined coupler positioned within the motor base 405, the splined coupler being connected to a motor shaft. Accordingly, when the blade base 528 is positioned within the motor base 405, rotation of the motor shaft caused by actuation of the motor is thereby transferred to the blade assembly 624, which are rotatably positioned within the blade base 528.

As shown in FIG. 5, the blade base 528 may include the engagement mechanism 672 configured to operatively and selectively engage with the blending container 532. The engagement mechanism 672 may be of any appropriate configuration and type, including, in an example, a threaded portion, a bayonet engaging member, or the like. In an embodiment, the engagement mechanism 672 may be located on the outer wall 629 of the blade base 528 and at or near the open end of the blade base 528. The engagement mechanism 672 may include stepped rims (not shown). The stepped rims (not shown) may include different locking mechanisms and, in an embodiment, may allow different adaptors or containers to attach.

An expanded view of an embodiment of the engagement mechanism 672 is shown in FIG. 6. It is noted that the engagement mechanism 672 may also be referred to as and include a locking or sealing mechanism and that locking mechanism 700 may generally refer to the engagement mechanism 614 of the blending container 532 and the corresponding engagement mechanism 672 of the blade base 528. The engagement mechanism 672 of the blade base 528 may selectively engage with or interlock with a corresponding portion of the blending container 532, e.g. engagement mechanism 614 of the blending container 532 as described herein.

In an embodiment, the blade base engagement mechanism 672 of the locking mechanism 700 may include threads or lugs 715 configured to receive or operatively engage with corresponding threads 710 of the blending container 532. The threads or lugs 715 may be disposed on an outer wall 629 of the blade base 528 and at or near the open end 652 of the blade base 528. The engagement mechanism 672 may further include a lead in feature (not shown) to make attachment of the locking mechanism 700 and securing to the blending container 532 easier. The engagement mechanism 672 may include a physical stop 736 to stop the blending container 532 from continuing to rotate relative to the blade base 528 once a certain desired threading has been engaged. The stop 736 may prevent the blade base 528 from being over-rotated relative to the blending container 532.

In an embodiment, the blade base engagement mechanism 672 of the locking mechanism 700 may include the locking protrusion 725, which may be disposed on an outer wall 629 of the blade base 528 and at or near the open end of the blade base 528. The locking protrusion 725 may be actuated or positionable in a locked position and an unlocked position via an actuator or push button 727. In an embodiment, the actuator 727 may be a push button such as a manual push button or any kind of actuating device. For example, the push button 727 may be biased in a locked position where the locking protrusion 725 is forced away from the outer wall 629 of the blade base 528. The push button 727 may be pushed to cause the locking protrusion 725 to depress into an unlocked position and thereby release the blade base 528 from the blending container 532 by pulling the locking protrusion 725 out of the locking groove 9720. In an embodiment, the locking protrusion 725 may be configured to receive a corresponding locking groove 720 on the blending container 532.

In an embodiment, the locking protrusion 725 of the blade base engagement mechanism 672 is configured to selectively engage the corresponding locking groove 720 of the blending container engagement mechanism 614, to thereby engage and selectively couple, lock, and/or seal the blade base 528 with the blending container 532. In an embodiment, the blade base 528 includes a sealed position to form a liquid tight seal with the interior side 608 of the blending container 532. In an embodiment, the seal may be a pressure release seal where liquid or air can be released when a certain pressure is reached. This may reduce pressure build up within the blending container 532.

In an embodiment, the blade base 528 does not cover the rim 534 of the open end 613 of the blending container 532. For example, in an embodiment, the blade base 528 does not include a collar or any portion that covers the rim 534 of the open end 613 of the blending container 532. In an embodiment, the push button 727 may differ from traditional latches and may not include or require pinch points and exposed hinges, which can collect food debris and cause issues when cleaning. In an embodiment, the lugs and threads 715 of the blade base 528 and/or the threads 710 of the blending container 532 are not enclosed, e.g., they do not include a “U” or other shape or end which can trap foodstuff or blended items.

Although embodiments including mating threads and a groove/protrusion structure may be described herein as comprising the locking mechanism 700, it is noted that different threads, grooves, slots, or other engagement can be used. Although embodiments including a manual push button structure may be described herein as comprising the locking mechanism 700, it is noted that thumb switches or other mechanisms can be used. It is further noted that while embodiments herein described may refer to a personal blender cup or a cup that attaches to a blade base by its open end, it is noted that other blending containers may be used with the described aspects, including the locking mechanism 700, including containers having various sizes and capacities, large format cups, cups that include an integrated blade assembly or that attach to a motor base 405 by its closed end, and the like. Moreover, the described locking mechanism 700 may be used to facilitate using various cups or adaptors with the same blade base or motor base. Such locking mechanism may also be used to attach a lid to a container and any other components within the blending system.

When engaged in a locked position where the blending container 532 is coupled to the second blending base 528, any material exiting from the assembled blending container 532 and second blending base 528 will be directed downward and not out or upwards toward a user.

As further described herein, it is also noted that the locking mechanism 700 having a mechanical interlock may be used in conjunction with a wireless interlock feature. It is also noted that a wireless interlock feature may be used in place of the mechanical interlock and vice versa. In an example, either or both the blending container 532 and second blending base 528 can include an NFC, RFID, mechanical, or other interlock. The interlock can prevent operation of the blade base, e.g. blade base 528, unless the blending container, e.g., blending container 532, is properly attached and the blade base and blending container assembly are placed on the motor base, e.g., motor base 405. In an embodiment, the push button may also include an interlock which causes the motor base, e.g., motor base 405 to disable the motor and prevent blending if the push button is pressed while the blending container/blade base assembly is on the blender base.

Such locking mechanism 700 and resulting sealing of the blending container 532 to the blade base 528 can provide ease of assembling/disassembling the blending system, can provide ease in cleaning with reduced buildup of foodstuff and no pinch points, and can provide and effective and reliable seal for the blending system.

As described above, the blending container 532 may be configured as a drinking vessel. In these embodiments, the blending container 532 is able to easily convert from a blending container to a drinking vessel. For example, in addition to the open end 613, the blending container 532 may include a closed end 619 generally opposite the open end 613. When the blending container 532 is operatively secured to the blade base 528, the housing 620 of the blade base 528 may be configured such that the housing 620 may create additional blending space for the material to be blended. As an example, the location of the blade assembly 624 within the housing 620 may be generally cup-shaped, which may provide this additional blending space. When removed from the blade base 528, the blending container 532 may function as a drinking vessel.

In some embodiments, the blending container 532 may include a lid (not shown) that is selectively engageable with the open end 613 of the blending container 532. The lid may be of any appropriate configuration and may be selectively engageable with the open end 613 in any appropriate manner, including, without limitation via a snap-fit, a threaded engagement, or any appropriate means. The lid may further include a cap that is positionable to and from open and closed positions to allow access to blended contents in the blending container 532 when in an open position and to prevent blended contents from exiting the blending container 532 when in a closed position (e.g. for storage or travel).

The interior surfaces 608, 628 of the blending container 532 and blade base 528, respectively, may generally define a surface that assists in flow of foodstuff within the assembly when blending foodstuff. In an example, the interior surfaces 608, 628 may be curved, convex, concave, sloped, or otherwise angled to direct a first flow towards the blade assembly 624 and direct a second flow of foodstuff that has passed through a path of the blade assembly 624 away from the blade assembly 624 to create and continue flow path that forces foodstuff into the path of the blade assembly 624.

It is further noted that the blending container 532 and blade base 528 may provide a seal between the components. In an example, a sealing gasket 744, may be disposed between the blending container 532 blade base 528 when they are operatively engaged together. The sealing gasket 744 may comprise an elastomeric material that is compressible to form a liquid tight seal.

In an embodiment, the blending system may include one or more sensors to detect whether the blending container, e.g. 532, is sealingly engaged with blade base, e.g. 528, (and/or whether the assembly is positioned on the motor base, e.g. 405). If the sensors detect that the components are not sealingly engaged, the driver circuit (in communication with one or more of the blade assembly, drive shaft, motor, power source, blades, etc.) may prevent or terminate operation of the motor, and/or generate error messages or warnings (e.g., via audio, video, tactile, or other forms of communication). In at least one example, the sensors may include pressure sensors, proximity sensors, optical sensors, or the like. The sensors may detect the presence or lack thereof of the blending container or assembled blending container and blade base. In at least one example, at least two sensors may be spaced apart from each other. In another example, at least three sensors are spaced out from each other. If less than all of the sensors detect proper assembly and connection of components, the driver circuit may prevent or cease operation of the motor.

Further, the blending container, e.g. 532, blade base, e.g. 528, and/or motor base, e.g. 405 may include wireless or wired actuator circuits that interact with each other to determine whether one or more, or all, or the components are operatively attached. For instance, the components may include NFC devices that may communicate with each other, magnetic sensors (e.g., a reed switch), tactile buttons and corresponding physical actuators, or the like. As shown in FIG. 5, the blade base 528 may include a reed switch or switches 747 and magnets. In an embodiment, the switches 747 may be closed by mechanically pushing the side button 747 on one or more sides of the blade base 528. Magnets may close the circuit. As an example, blending container 532 may be able to detect the blade base 528 or vice versa, either or both which may be able to detect motor base 405, or vice versa. If the components (for example, one or more of the blending container 532, blade base 528, or motor base 405) are not in place, e.g., is not engaged or sealingly engaged, the driver circuit may not drive the blade assembly 624. Such detection can be accomplished by magnetic/reed switch, momentary switch, IR sensor, etc. This can prevent activation of the motor or blade assembly 624 when the blade base 528 is not attached to the blending container 532 and/or the motor base 405 or when the blade base 528 may be at risk of becoming disengaged from either during blending.

In an exemplary embodiment, the blending container 532 does not include any magnets or other wireless devices. Instead, the blending container 532 presses against or otherwise engages reed switches on the outer wall 629 of the blade base 528 to close the reed switches, as described in more detail above. The motor base 405 will only drive the blade assembly 624 if the reed switches are pressed and/or the locking protrusion 725 is in a locked position. In such embodiments or other embodiments, the motor base 405 may include an NFC tag that communicates with the motor base 405 or more specifically the controller 455 controlling the motor such that only when the blending container 532 is operatively attached with the motor base 405 the motor will operate. An exemplary embodiment is disclosed in U.S. Patent Publication No. 20200008626, which is incorporated herein by reference.

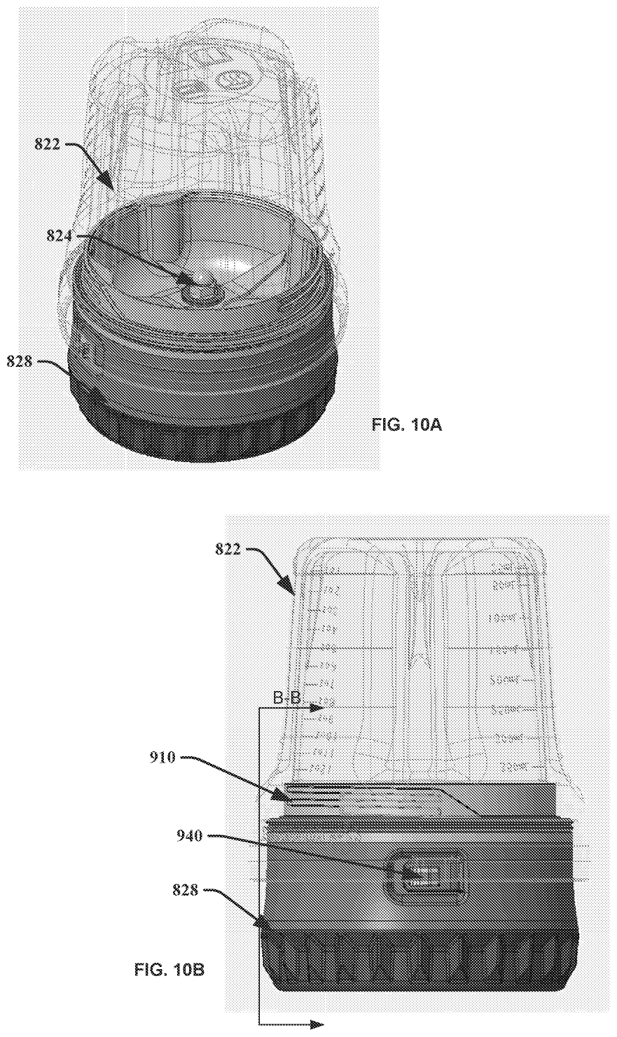

FIGS. 10-19 show embodiments of a blending container 832, 822 and blade base 828 that may be used in blending system 350, e.g., with motor base 405. The blade base 828 may operatively attached to the blending container 832 and the motor base 405 at opposite ends, as is shown in respect to blending containers 532, 522 in FIG. 1. As described, the motor base 405 may house a motor that operatively powers and drives the blades of the blade base 828 as further described herein. In some embodiments, the controller 455 may control operation or at least certain operation or non-operation of the motor. An example of this control is shown in U.S. Publication No. 2020/0275807A1, which is incorporated herein by reference in its entirety. It is noted that blending container 832, 822 and blade base 828 may generally have the same aspects as blending container 532, 522 and blade base 528 unless context or this disclosure describes otherwise. For example, blending container 832, 822 and blade base 828 may differ from blending container 532, 522 and blade base 528 in only the engagement and locking mechanisms. Any aspects and combination of aspects of blending container 532, 522 and blade base 528 may be applied to blending container 832, 822 and blade base 828.

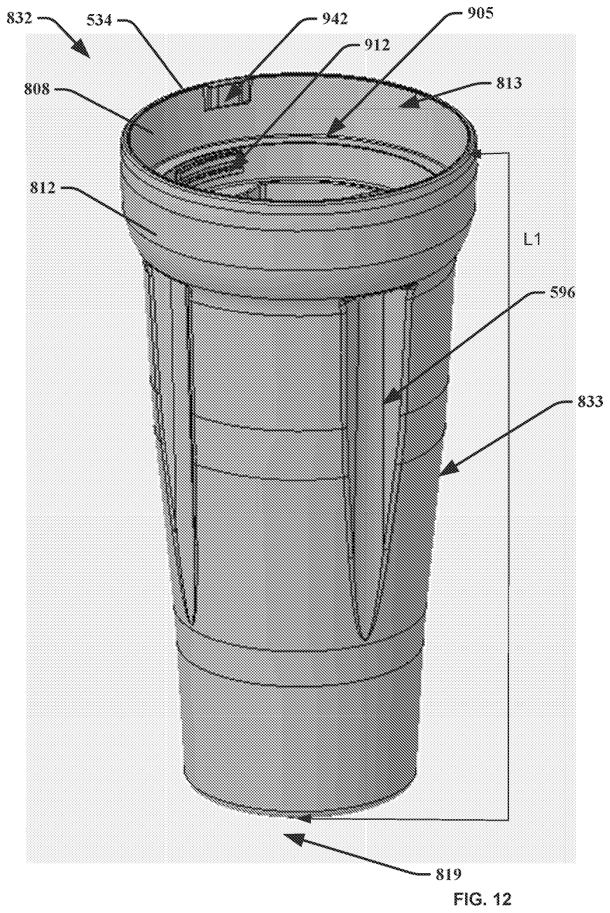

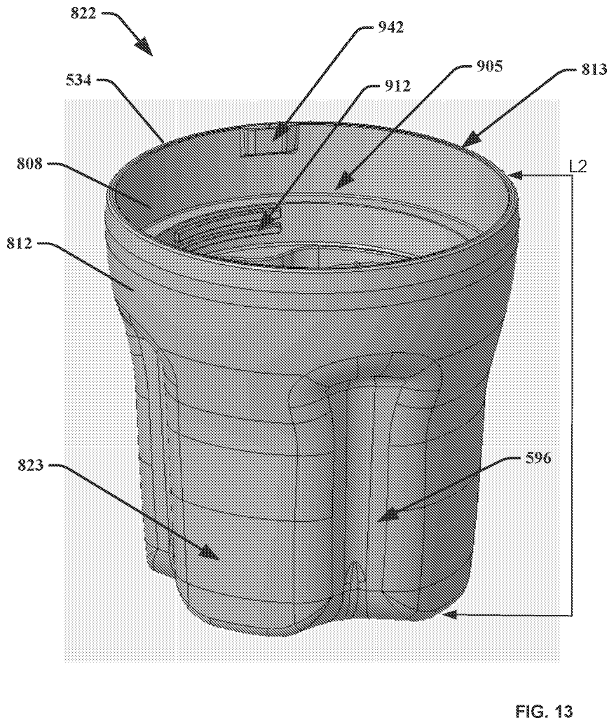

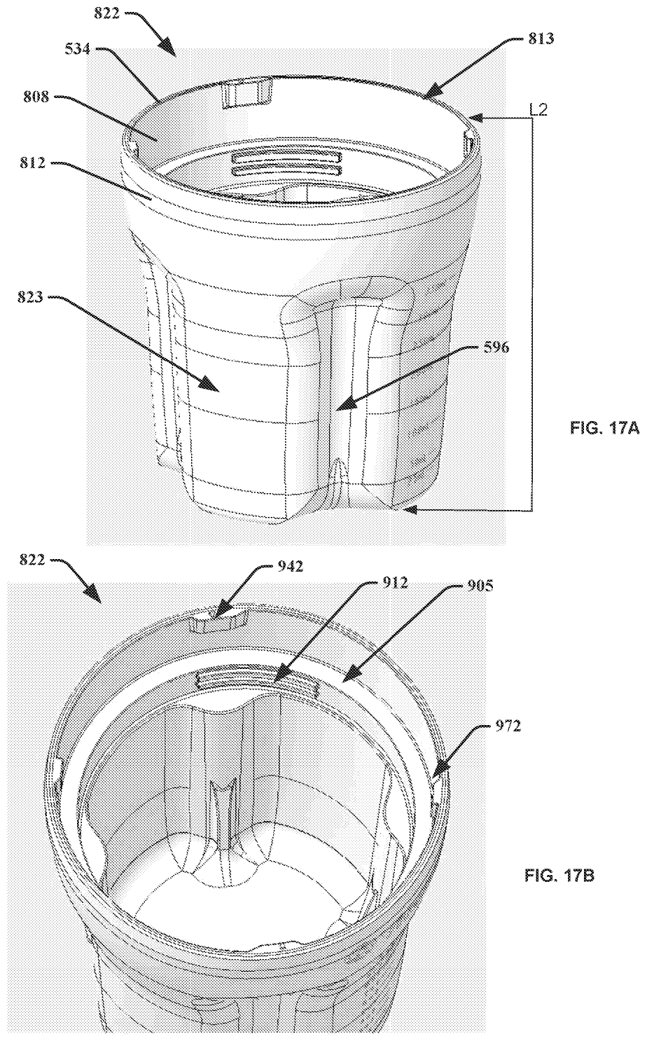

Turning to FIGS. 12-13 and 17A-B, shown are blending containers 832, 822. In an embodiment shown in FIG. 12, the blending container 832 includes at least one sidewall 833 extending to a lip or rim 534. The rim 534 can be a squared rim, rounded rim, have a ledge, etc. The blending container 832 may be a double-walled container (e.g. having an inner layer spaced apart from an outer layer), single-walled container, or the like. The at least one sidewall 833 may be generally circular. In an embodiment shown in FIGS. 13 and 17A-B, the blending container 822 includes at least one sidewall 823 extending to a lip or rim 534. The rim 534 can be a squared rim, rounded rim, have a ledge, etc. The blending container 822 may be a double-walled container (e.g. having an inner layer spaced apart from an outer layer), single-walled container, or the like. The at least one sidewall 823 may be generally circular.

As shown in FIG. 12, for blending container 832, the length of the at least one sidewall 833 may be a first length L1. As shown in FIGS. 13 and 17A-B, for blending container 822, the length of the at least one sidewall 823 may be a different, e.g., it may be of a shorter length L2. Blending containers 832, 822 of any capacity may be used in the present disclosure, including blending containers having the general shapes shown in FIGS. 12-13, and 17A-B. Blending containers 832, 822, in an example, may have all or some of the same features as described herein except for the capacity or length of corresponding sidewalls 833, 823. Any aspects described in reference to blending container 832 may also be applied to blending container 822 and vice versa, but may not be explicitly repeated for sake of brevity. It is noted that blending containers 832, 822 may be interchangeable with the same blade base 828 or other blade bases as described herein.

In an embodiment, the blending container 832 may be generally cylindrical, conical, or frustoconical, the closed end or open end generally circular (e.g. having a general circumference), and the sidewall(s) generally curved or round. It is also noted, however, that the blending container 832 may comprise any size and shape as desired, including round, square, rectangular, irregular, or the like. Additionally, the blending container 832 may comprise multiple shapes, for example the closed end or open end generally circular while the sidewall(s) are squared. It is noted that terms such as circumference, diameter, etc., while including round, circular, and cylindrical shapes, may also refer to the periphery or general aspects of a non-circular or round shape, such as a squared shape.

Further, unless context suggests otherwise, descriptions of shapes (e.g., circular, rectangular, squared, triangular, etc.) and the nature of the shapes (e.g., straight, curved, rounded, etc.) refer to shapes meeting the definition of such shapes and general representation of such shapes. For instance, a triangular shape or generally triangular shape may include a shape that has three sides and three vertices or a shape that generally represents a triangle, such as a shape having three major sides that may or may not have straight edges, triangular like shapes with rounded vertices, etc. Additionally, as used herein, the word near may be used to describe an aspect that is directly adjacent to or at another aspect, relatively close to another aspect, that is within 1-3 cm.

Moreover, a sidewall may have any number of sides, such as 1, 2, 3, 4, 5, 6, 7, 8, 9, 10, etc. sides, and may generally adopt the shape of a parallelogram, circle, rectangle, square, portion of any of the foregoing, or the like. A sidewall or sidewalls, although encompassing a cavity therein, may also be referred to in a singular form or a plural form. Edges and corners of sidewall(s), or portions connecting sidewall(s), may similarly have any number of sides, such as 1, 2, 3, 4, 5, 6, 7, 8, 9, 10, etc. sides, and may generally adopt the shape of a parallelogram, circle, rectangle, square, portion of any of the foregoing, or the like. Although general measurements or indications of height, length, width, distance, thickness, and angles may be disclosed, it is noted that these aspects are broadly defined within this disclosure unless specifically indicated for a particular embodiment.

The blending container 832 may include elongated ribs or flutes 596 projecting from an interior side 808 of the blending container 832 and into a cavity or blending area. The elongated ribs or flutes 596 may also correspond to a depression on the exterior side 812 of the blending container 832. The ribs 596 may comprise one or more protrusions generally spanning a length or a substantial length of the at least one side wall 833 or of the blending container 832. In an example, the ribs 596 may span from a point at, near or adjacent to an open end 813 to a point at, near or adjacent to a closed end 819 of the blending container 832. In an example, the ribs 596 may span from a point spaced apart from or below the open end 813 to a point spaced apart from or below the closed end 819 of the blending container 832. It is also noted that the ribs 596 may include any combination of the above, including ribs 596 may be spaced apart from the open end 813 but may extend up to the closed end 819, etc.

The ribs 596 may have generally the same width across its lengths, or the ribs 596 may taper towards either or both ends. As shown in FIG. 12, in an example, the blending container 832 may comprise at least two ribs 596 spaced at opposing sides of the blending container 832. As shown in FIG. 12, in an example, the blending container 832 may comprise four ribs 596 spaced evenly around the at least one sidewall 833 and at opposing sides of the blending container 832. It is noted that the blending container 832 may comprise any number of ribs 596 as desired including 1, 2, 3, 4, 5, 6, 7, 8, 9, 10, etc., and may have the same or differing shapes or positions on the at least one side wall 833 or on the blending container 832. The ribs 596 may be configured to aid in agitating the contents of the blending container 832 during blending. The blending container 832 may also include a plurality of fins.

As described, the blending container 832 may include the open end 813 through which material or foodstuff may be inserted in advance of blending and through which material or foodstuff may exit after blending. The open end 813 may be of any appropriate configuration and size. The open end 813 may be of a configuration to permit a user to drink directly therefrom. This may result in the blending container 832 being capable of utilization as a drinking vessel.

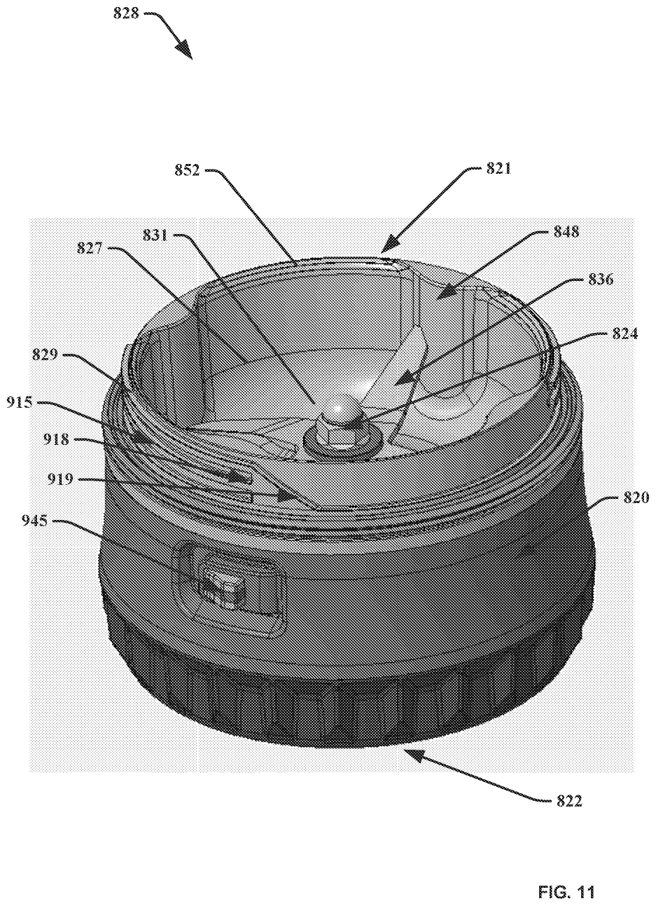

Turning to FIGS. 11-16, shown are embodiments of a blade base 828. The blade base 828 may be sized and shaped to operatively fit within an opening or mount 416 in the motor base 405 in any appropriate manner. The blade base 828 may include a housing 820 having a first side 821 and a second side 822. A blade assembly 824 is positioned within the first side 821 of the housing 820. The housing 820 may be of any appropriate configuration. For example, the housing 820 may include an inner wall 827 that is rectangular and wherein the corners are used for agitating the contents of the attached blender container 832. For example, the housing 820 may include an inner wall 827 and an outer wall 829 that is generally circular. In an embodiment, the housing 820 may be an over-molded water shield housing. In an embodiment, the housing 820 may make the blade base 828 dishwasher safe. The housing 820 may further include an ergonomic hand grip to facilitate blade base 828 assembly and removal from associated components within the system 350 and may engage with the motor base 405 centering pad. The blending container 832, 822 may be similarly ergonomic to facilitate blending container 832, 822 assembly and removal from associated components within the system 350.

In an embodiment, the blade base 828 may include features to agitate the flow of material with the blender container 832. For example, the blade base 828 may break up flow of material within the blender container 832 during operation of the blending system 350. In an embodiment, the blade base 828 may include one or more protrusions 848 extending from the inner wall 827 on the first side 821 of the blade base 828. The one or more protrusions 648 may be of any appropriate shape and size, such as generally rounded. The one or more protrusions 848 may be monolithically formed with the inner wall 827 or may be attached through a subsequent operation. The one or more protrusions 848 may be approximately ½ inch in diameter. The one or more protrusions 848 may extend from a length of the blade base 828 from a bottom surface 831 to an open top end 852. The area of the blade base 828 from its bottom surface 831 to its open top end 852 may provide additional area to facilitate blending of foodstuff and may provide a blend zone enclosure.

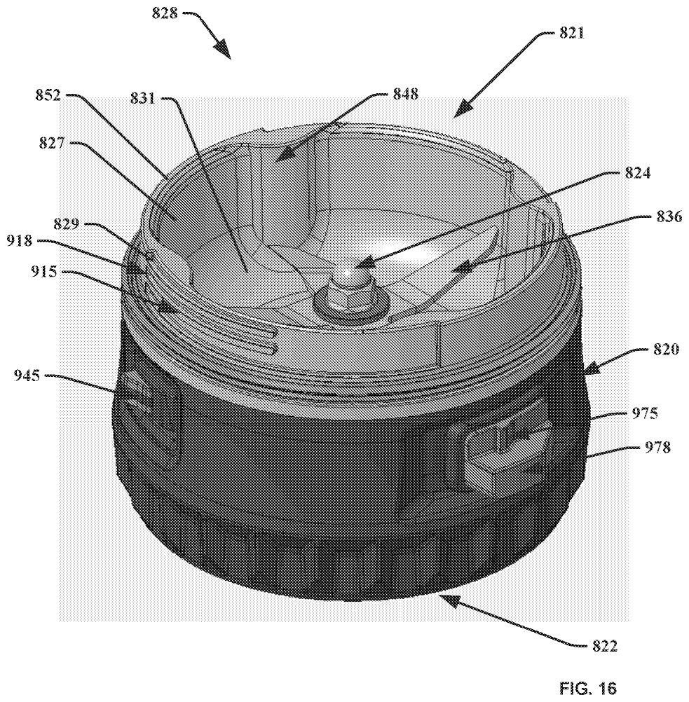

It will be appreciated that the blade base 828 may include more than one protrusions 848. As shown in FIGS. 11 and 16, in an example, the blade base 828 may comprise at least two protrusions 848 spaced at opposing sides of the blade base 828. As shown in FIGS. 11 and 16, in an example, the blade base 828 may comprise four protrusions 848 spaced evenly around the inner wall 827 and at opposing sides of the blade base 828. It is noted that the blade base 828 may comprise may comprise any number of protrusions 848 as desired including 1, 2, 3, 4, 5, 6, 7, 8, 9, 10, etc., and may have the same or differing shapes or positions on the inner wall 827 or on the blade base 828. The one or more protrusions 848, in an example, may assist in the blending process and may be used for agitation, etc. For example, the one or more protrusions 848 may direct foodstuff back towards the blade assembly 824 during blending and prevent the accumulation of foodstuff towards the sides of the blending container 832 where it may not be adequately blended.

The blade assembly 824 may be connected to the housing 820 in any appropriate manner. The blade assembly 824 may be of any appropriate configuration, type and size. The present teachings are not limited to the configuration shown and described. By way of a non-limiting example, the blade assembly 824 can be of a conventional blender blade configuration and, as such, includes a plurality of radially extending blades 836 that are carried by, and positioned above the bottom surface 831 of the blade base 828 by a vertically oriented blade shaft (not shown). The blade shaft may extend downwardly through the bottom surface of the blade base 828 to a second side of the blade base 828. A spline (not shown) may secure to the end of the blade shaft on the second side of the blade base 828. The spline of the blade shaft engages with a splined coupler positioned within the motor base 405, the splined coupler being connected to a motor shaft. Accordingly, when the blade base 828 is positioned within the motor base 405, rotation of the motor shaft caused by actuation of the motor is thereby transferred to the blade assembly 824, which are rotatably positioned within the blade base 828.

As shown in FIGS. 10-19, the blending container 822 and the blade base 828 may include an engagement mechanism 910 to facilitate attachment between the blending container 822 and the blade base 828, wherein a mating portion 912 on blending container 822 and may operatively and selectively engage, mate, or interact a corresponding mating portion 915 on the blade base 828. The engagement mechanism 910 and associated mating portions 912, 915 may be of any appropriate configuration and type, including, in an example, threading, bayonet connectors, fasteners, other mating protrusions and recesses, or the like. In an embodiment and as shown in FIGS. 10-19, the engagement mechanism 910 and associated mating portions 912, 915 may include mating threading. In an embodiment, the threading 912, 915, for example, may be include portions of threading circumscribing the (interior of the) blending container 822 and circumscribing the (exterior of the) blade base 828, and portions between the threading that are not threaded (e.g., “pockets”). For example, each component of the blending container 822 and the blade base 828 may include one or more areas of threading, e.g., two areas of threading 180° apart and may include areas that are not threaded. In an embodiment, the mating portion 912 of the blending container 822 may be located at or near the open end 813 of the blending container 822 and on the interior side 808 of the blending container 822. The engagement mechanism 910 may include stepped rims 905. The stepped rims 905 may include different locking mechanisms and, in an embodiment, may allow different adaptors or bases to attach.

The engagement mechanism 910 may include a physical stop 918 or interruption to stop the blending container 822 from continuing to rotate relative to the blade base 828 once a certain desired threading has been engaged. In an example, the stop may prevent the blade base 828 from being over-rotated or overtightened relative to the blending container 832. In an example and as shown in FIGS. 11 and 16, a physical stop 918 may be provided on the threading or mating portion 915 of the blade base 828. In an embodiment, a physical stop could be provided on the blending container 822. In an embodiment, the engagement mechanism 910 may provide for either clockwise or counterclockwise rotation to provide engagement between the blending container 822 and the blade base 828. In an embodiment, two areas of threading 180° apart on each the blending container 822 and the blade base 828 may provide for a quarter-turn operation. In an example, FIG. 11 may illustrate counterclockwise rotation (e.g., left-handed) of the blade base 828 in relation to the blending container 822 and FIG. 16 may illustrate clockwise rotation (e.g., right-handed) of the blade base 828 in relation to the blending container 822.

The engagement mechanism 910 may include a ramp up 919 to facilitate removal of the blade base 828 after blending. The ramp up 828 may be positioned at, near, or adjacent the corresponding mating portion 912, 915. In an example and as shown in FIG. 11, the ramp up 919 may be provided on the blade base 828 at, near, or adjacent the corresponding mating portion 915 of the blade base 828. The ramp up 919 may direct the threads or mating portion 912 of the blending container 822 up the ramp to disengage from the blade base 828 when rotated accordingly. In an embodiment, a ramp up could be provided on the blending container 822. The ramp-up may correspond with the mating or threaded portions and, in an example, may be provided twice 180° apart.

As shown in FIGS. 10-19, the blending container 822 and the blade base 828 may include an interlock 940 to determine when components of the blending system 350 are properly assembled. For example, the blending container, e.g. 822, blade base, e.g. 828, and/or motor base, e.g. 405 may include wireless or wired actuator circuits that interact with each other to determine whether one or more, or all, or the components are operatively attached. For instance, the components may include NFC devices that may communicate with each other, magnetic sensors (e.g., a reed switch), tactile buttons and corresponding physical actuators, or the like.

As shown in FIGS. 12-13 and 17A-B, the blending container 832, 822 may include a tab 942. In an embodiment, the blending container 832, 822 may include one or more tabs 942, for example, two areas of threading 180° apart. The tabs 942 may be located at or near the open end 813 of the blending container 822 and on the interior side 808 of the blending container 822. The tabs 942 (and interlock 940) may be located on a different stepped rim 905 of the blending container 822 than the mating portion 912 (and engagement mechanism 910).

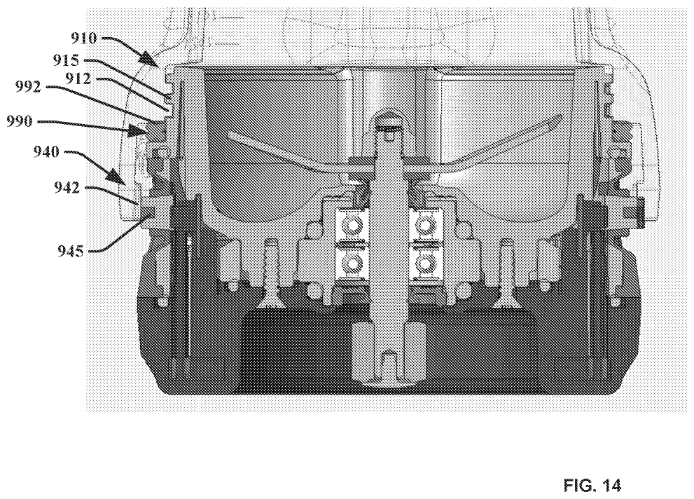

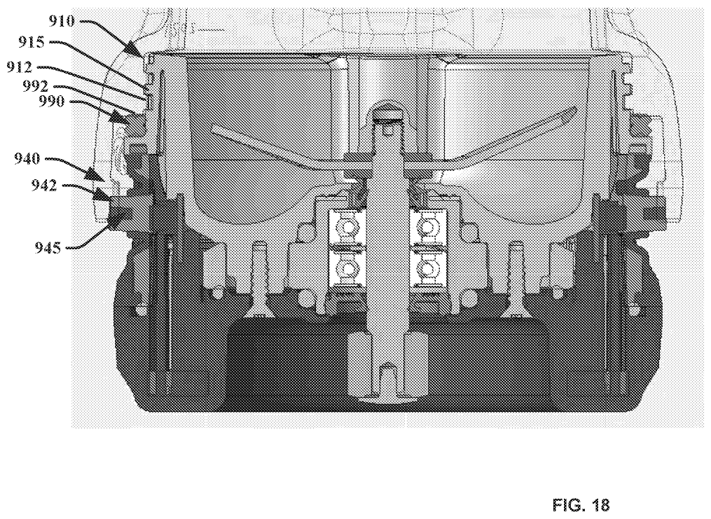

As shown in FIGS. 11 and 16, the blade base 828 may include a reed switch or switches 945. In an embodiment, the switches 947 may be located on the outer wall 829 of the blade base 828 and at or near the open end of the blade base 828. In an embodiment, the switches 945 may be closed mechanically by the tabs 942 on the blending container 822, see FIGS. 14 and 18. As an example, blending container 822 may be able to detect the blade base 828 or vice versa, either or both which may be able to detect motor base 405, or vice versa. If the components (for example, one or more of the blending container 822, blade base 828, or motor base 405) are not in place, e.g., is not engaged or sealingly engaged, the driver circuit may not drive the blade assembly 624. Such detection can be accomplished by magnetic/reed switch, momentary switch, IR sensor, etc. This can prevent activation of the motor or blade assembly 824 when the blade base 828 is not attached to the blending container 822 and/or the motor base 405 or when the blade base 828 may be at risk of becoming disengaged from either during blending.

In an exemplary embodiment, the blending container 822 does not include any magnets or other wireless devices. Instead, the blending container 822 and associated tabs 942 press against or otherwise engage reed switches 945 on the outer wall 829 of the blade base 828 to close the reed switches, as described in more detail above. The motor base 405 will only drive the blade assembly 824 if the reed switches are pressed and/or the locking protrusion 975 is in a locked position. In such embodiments or other embodiments, the motor base 405 may include an NFC tag that communicates with the motor base 405 or more specifically the controller 455 controlling the motor such that only when the blending container 822 is operatively attached with the motor base 405 the motor will operate. An exemplary embodiment is disclosed in U.S. Patent Publication No. 20200008626, which is incorporated herein by reference.

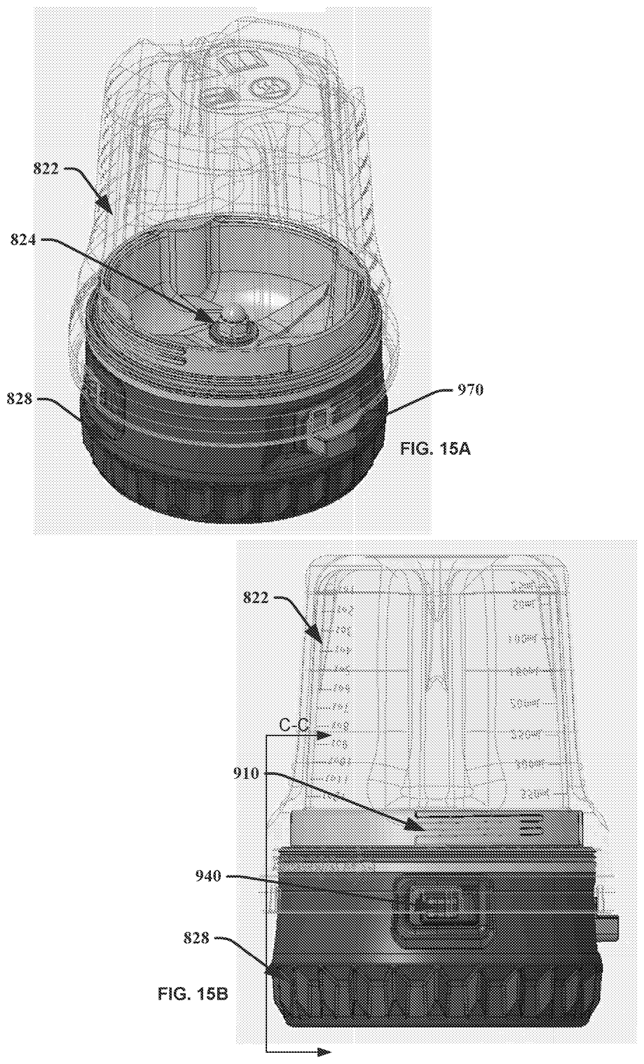

As shown in FIGS. 15-19, the blending container 822 and the blade base 828 may include a locking mechanism 970 to lock or secure the blending container 822 and the blade base 828 when properly attached, wherein a mating portion 972 on blending container 822 and may operatively and selectively engage, mate, or interact a corresponding mating portion 975 on the blade base 828. The locking mechanism 970 and associated mating portions 972, 975 may be of any appropriate configuration and type, including, in an example, threading, bayonet connectors, fasteners, other mating protrusions and recesses, or the like. In an embodiment and as shown in FIGS. 15-19, the locking mechanism 970 and associated mating portions 972, 975 may include mating grooves and protrusions.

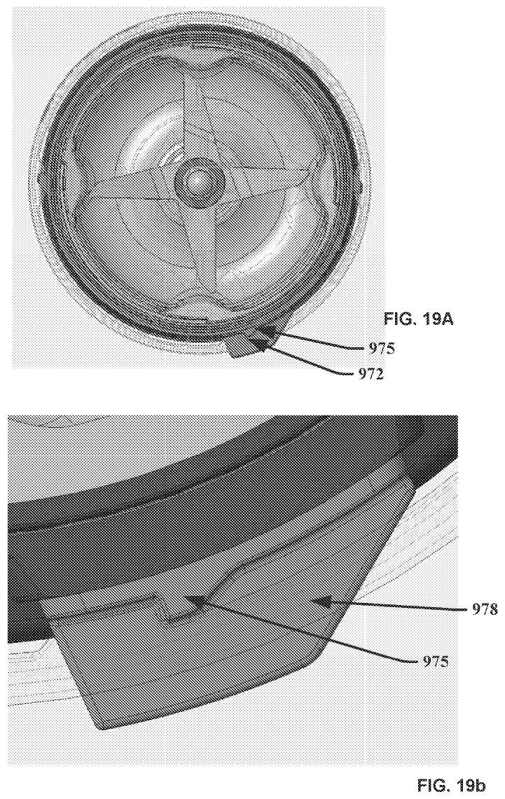

In an embodiment, the mating portion 972 of the blending container 822 may include a locking groove disposed within or on an inner wall 808 of the blending container 822 and at or near the open end 813 of the blending container 822. In an embodiment, the locking groove 972 may be configured to receive a corresponding locking member or protrusion 975 from an actuator or button 978 of the blade base 828 see FIGS. 19A-B showing engagement of the blending container 822 and the blade base 828. In an embodiment, the locking groove 972 may be located at or near the open end 813 of the blending container 822 and on the interior side 808 of the blending container 822. The locking groove 972 (and locking mechanism 970) may be located on a different stepped rim 905 of the blending container 822 than the mating portion 912 (and engagement mechanism 910).

It is noted that the locking groove and locking member may be reversed so that the locking groove is positioned on the blade base and the locking member is positioned on the blending container. It is noted that each the blending container and the blade base may comprise a locking groove and a locking member, so that the locking groove on the blending container may interact with the corresponding locking member on the blade base and the locking member on the blending container may interact with the corresponding locking groove on the blade base. In an embodiment, the locking groove and locking member on the blending container may be adjacent and the “groove” may be apparent from the adjacent “protrusion” and vice versa where the “protrusion” may be apparent from the adjacent “groove.” Similarly, in an embodiment, the locking groove and locking member on the blade base may be adjacent and the “groove” may be apparent from the adjacent “protrusion” and vice versa where the “protrusion” may be apparent from the adjacent “groove.”

In an embodiment, the mating portion 975 of the blade base 828 may include the locking protrusion, which may be disposed on an outer wall 829 of the blade base 828 and at or near the open end of the blade base 828. The locking protrusion 825 may be actuated or positionable in a locked position and an unlocked position via an actuator or push button 978. In an embodiment, the actuator 978 may be a push button such as a manual push button or any kind of actuating device. For example, the push button 978 may be biased in a locked position where the locking protrusion 975 is forced away from the outer wall 829 of the blade base 828. The push button 978 may be pushed to cause the locking protrusion 925 to depress into an unlocked position and thereby release the blade base 828 from the blending container 822 by pulling the locking protrusion 925 out of the locking groove 972. In an embodiment, the locking protrusion 975 may be configured to receive a corresponding locking groove 972 on the blending container 822.

In an embodiment, the locking groove 972 and corresponding locking protrusion 975 of the locking mechanism 970 is configured to selectively engage at the same time or simultaneously as the engagement mechanism 910 and interlock 940, and their corresponding components, engage, to thereby engage and selectively couple, lock, and/or seal the blending container 822 with the blade base 828. In an embodiment, the blending container 822 includes a sealed position to form a liquid tight seal with the outer side of the blade base 828. In an embodiment, the seal may be a pressure release seal of any appropriate configuration where liquid or air can be released when a certain pressure is reached. This may reduce pressure build up within the blending container 822.

It is further noted that the blending container 822 and blade base 828 may provide and include a seal between the components. In an example, a sealing gasket 990, may be disposed between the blending container 822 blade base 828 when they are operatively engaged together, see FIGS. 14 and 18, for example. The sealing gasket 990 may comprise an elastomeric material that is compressible to form a liquid tight seal. The sealing gasket 990 may be located on the blade base 828 and may but up to or contact a flat surface or wall 992 of the blending container 82 when the blade base 828 and the blending container 822 are selectively attached. In an embodiment, the sealing gasket 990 may be removable from the blade base 828.

In an embodiment, the blade base 828 does not cover the rim 534 of the open end 813 of the blending container 832. For example, in an embodiment, the blade base 828 does not include a collar or any portion that covers the rim 534 of the open end 813 of the blending container 832. In an embodiment, the push button 978 may differ from traditional latches and may not include or require pinch points and exposed hinges, which can collect food debris and cause issues when cleaning. In an embodiment, the mating portions of the blade base 828 and/or the mating portions of the blending container 822 are not enclosed, e.g., they do not include a “U” or other shape or end which can trap foodstuff or blended items.

Although embodiments including mating threads and a groove/protrusion structure may be described herein as comprising the engagement mechanism 910 and locking mechanism 970 respectively, it is noted that different threads, grooves, slots, or other engagement can be used. Although embodiments including a manual push button structure may be described herein as comprising the locking mechanism 970, it is noted that thumb switches or other mechanisms can be used. It is further noted that while embodiments herein described may refer to a personal blender cup or a cup that attaches to a blade base by its open end, it is noted that other blending containers may be used with the described aspects, including the mechanisms 910, 940, 970, including containers having various sizes and capacities, large format cups, cups that include an integrated blade assembly or that attach to a motor base 405 by its closed end, and the like. Moreover, the described engagement mechanism 910 and locking mechanism 970 may be used to facilitate using various cups or adaptors with the same blade base or motor base. Such mechanisms may also be used to attach a lid to a container and any other components within the blending system.

When engaged in a locked position where the blending container 822 is coupled to the second blending base 828, any material exiting from the assembled blending container 822 and second blending base 828 will be directed downward and not out or upwards toward a user.

As further described herein, it is also noted that the engagement mechanism 910 and locking mechanism 970 having a mechanical interlocks may be used in conjunction with a wireless interlock feature 940. It is also noted that a wireless interlock feature may be used in place of the mechanical interlock and vice versa. In an example, either or both the blending container 822 and blending base 828 can include an NFC, RFID, mechanical, or other interlock. The interlock can prevent operation of the blade base, e.g. blade base 828, unless the blending container, e.g., blending container 822, is properly attached and the blade base and blending container assembly are placed on the motor base, e.g., motor base 405. In an embodiment, the push button 978 may also include an interlock which causes the motor base, e.g., motor base 405 to disable the motor and prevent blending if the push button is pressed while the blending container/blade base assembly is on the blender base.

Such engagement mechanism 910 and locking mechanism 970 and resulting sealing of the blending container 822 to the blade base 828 can provide ease of assembling/disassembling the blending system, can provide ease in cleaning with reduced buildup of foodstuff and no pinch points, and can provide and effective and reliable seal for the blending system.

As described above, the blending container 822 may be configured as a drinking vessel. In these embodiments, the blending container 822 is able to easily convert from a blending container to a drinking vessel. For example, in addition to the open end 813, the blending container 822 may include a closed end 819 generally opposite the open end 813. When the blending container 822 is operatively secured to the blade base 828, the housing 820 of the blade base 828 may be configured such that the housing 820 may create additional blending space for the material to be blended. As an example, the location of the blade assembly 824 within the housing 820 may be generally cup-shaped, which may provide this additional blending space. When removed from the blade base 828, the blending container 822 may function as a drinking vessel.

In some embodiments, the blending container 822 may include a lid (not shown) that is selectively engageable with the open end 813 of the blending container 822. The lid may be of any appropriate configuration and may be selectively engageable with the open end 813 in any appropriate manner, including, without limitation via a snap-fit, a threaded engagement, or any appropriate means. The lid may further include a cap that is positionable to and from open and closed positions to allow access to blended contents in the blending container 822 when in an open position and to prevent blended contents from exiting the blending container 822 when in a closed position (e.g. for storage or travel).

The interior surfaces 808, 827 of the blending container 822 and blade base 828, respectively, may generally define a surface that assists in flow of foodstuff within the assembly when blending foodstuff. In an example, the interior surfaces 808, 827 may be curved, convex, concave, sloped, or otherwise angled to direct a first flow towards the blade assembly 824 and direct a second flow of foodstuff that has passed through a path of the blade assembly 824 away from the blade assembly 824 to create and continue flow path that forces foodstuff into the path of the blade assembly 824.

In an embodiment, the blending system may include one or more sensors to detect whether the blending container, e.g. 822, is sealingly engaged with blade base, e.g. 828, (and/or whether the assembly is positioned on the motor base, e.g. 405). If the sensors detect that the components are not sealingly engaged, the driver circuit (in communication with one or more of the blade assembly, drive shaft, motor, power source, blades, etc.) may prevent or terminate operation of the motor, and/or generate error messages or warnings (e.g., via audio, video, tactile, or other forms of communication). In at least one example, the sensors may include pressure sensors, proximity sensors, optical sensors, or the like. The sensors may detect the presence or lack thereof of the blending container or assembled blending container and blade base. In at least one example, at least two sensors may be spaced apart from each other. In another example, at least three sensors are spaced out from each other. If less than all of the sensors detect proper assembly and connection of components, the driver circuit may prevent or cease operation of the motor.

It is further noted that any or all of the described components may be dishwasher safe, such as hermetically sealed to prevent foodstuff or liquid from entering into the cavity and interacting with the power source, motor, driver circuit, or other operative elements.

In an embodiment, the blending cups may be blow-molded. The blending cups may also be injection-molded, etc., and may include any desirable plastic or material in the art.

What has been described above includes examples of the present specification. It is, of course, not possible to describe every conceivable combination of components or methodologies for purposes of describing the present specification, but one of ordinary skill in the art may recognize that many further combinations and permutations of the present specification are possible. Each of the components described above may be combined or added together in any permutation to define embodiments disclosed herein. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

1. A blender, comprising:
a blade base comprising a first end and a second end, wherein the second end is selectively attachable to a motor base and wherein the motor base comprises a motor and operation of the motor is controlled by a controller;
a container having an open end and an inner wall, wherein the container comprises a rim at the open end, and wherein the blade base does not cover the rim of the open end when the blade base is selectively attached to the container; and
an actuator and a locking member, wherein the locking member is positionable in a locked position and an unlocked position via the actuator, wherein the locking member is located on an outer wall of the blade base and configured to selectively engage with a locking groove on or within the inner wall of the container, and wherein release of the locking member from the locking groove is actuated by depression of the actuator.

2. The blender of claim 1, wherein the depression of the actuator pulls the locking member into the outer wall of the blade base.

3. The blender of claim 1, wherein the actuator is a manual push button.

4. The blender of claim 1, wherein the blade base comprises mating threads located on an exterior of the blade base, wherein the container comprises mating threads on the inner wall of the container, and wherein the mating threads of the container are configured to selectively engage with the mating threads of the blade base.

5. The blender of claim 4, wherein the mating threads of the blade base comprise a hard stop to prevent further rotation of the container and the blade base.

6. The blender of claim 4, wherein the mating threads of the container are engageable to the mating threads of the blade base in either a clockwise direction or a counterclockwise direction.

7. The blender of claim 4, wherein engagement of the mating threads on the container and mating threads on the blade base form a liquid seal.

8. The blender of claim 1, wherein the blade base comprises a first interlock component and the container comprises a second interlock component operatively interacting with the first interlock component; and
wherein the controller operatively controls operation of the motor based at least in part on whether the first interlock component is interacting with the second interlock component.

9. The blender of claim 8, wherein the first interlock component of the blade base comprises a switch that is engageable by a tab on the container.

10. The blender of claim 1, wherein the blade base comprises a first interlock component and the motor base comprises a second interlock component operatively interacting with the first interlock component; and
wherein the controller operatively controls operation of the motor based at least in part on whether the first interlock component is interacting with the second interlock component.

11. A blender, comprising:
a container comprising a closed end, an open end, and a rim at the open end;
a base comprising a blade assembly at a first end;
a protrusion positioned on an exterior wall of the base; and
a groove positioned on an interior wall of the container, wherein the protrusion on the base is selectively insertable into the groove on the container and wherein engagement of the protrusion and the groove locks the container into a sealed position on the base.

12. The blender of claim 11, wherein the base does not cover the rim of the container when selectively attached to the container.

13. The blender of claim 11 further comprising an actuator that transitions the protrusion from a protruded state to an inserted state.

14. A blending system, comprising:
a blade base comprising an actuator and a locking protrusion positionable in a locked position and an unlocked position via the actuator;
a container having an open end, a rim at the open end, and a locking groove disposed within or on an inner wall of the container, wherein the locking protrusion engages the locking groove to engage the blade base with the container; and
a first interlock component in the container and a second interlock component in the blade base operatively interacting with the first interlock component, wherein a controller operatively controls operation of a motor based at least in part on whether the first interlock component is interacting with the second interlock component.

15. The blending system of claim 14, further comprising a third interlock component in a base containing the motor, the third interlock component operatively interacting with the second interlock component, wherein the controller operatively controls operation of the motor based at least in part on whether the first interlock component is interacting with the second interlock component and the second interlock component is interacting with the third interlock component.

16. The blending system of claim 15, wherein at least one of the first, second, or third interlock comprise a reed switch and magnet.

17. The blending system of claim 14, wherein the blade base does not cover the rim of the open end of the container.

18. The blending system of claim 14, further comprising threads on the inner wall of the container and mating threads on an outer wall of the blade base.

19. The blending system of claim 18, wherein engagement of the threads on the container and mating threads on the blade base form a liquid seal.

20. The blending system of claim 14, wherein depression of the actuator pulls the locking protrusion into an outer wall of the blade base.
